(19) United States
(12) Patent Application Publication
(10) Pub. No.: US 2025/0076564 A1
(43) Pub. Date: Mar. 6, 2025

(54) BULK OPTIC COMPONENTS INTEGRATED WITH OPTICAL WAVEGUIDES

(71) Applicant: LioniX International BV, Enschede (NL)

(72) Inventors: Ronald DEKKER, Enschede (NL); Philip Paul Joao SCHRINNER, Ahaus (DE)

(21) Appl. No.: 18/819,110

(22) Filed: Aug. 29, 2024

Related U.S. Application Data
(60) Provisional application No. 63/535,441, filed on Aug. 30, 2023.

(51) Int. Cl. F21V 8/00; G02B 6/26

(52) U.S. Cl. CPC G02B 6/0075; G02B 6/003; G02B 6/005; G02B 6/0065; G02B 6/264

(57) ABSTRACT

A bulk optic component and optical waveguides are integrated on a common substrate in a manner that reduces reflections and scattering arising at the interfaces between the various elements. In particular, the bulk optic component is located in the optical path between first and second optical waveguides such that light exiting the first optical waveguide enters the bulk optic component, which is butt-coupled to the exit facet of the first optical waveguide. A refocusing lens that is disposed on an exit surface of the bulk component directs the light into the second optical waveguide. Examples of such bulk optic components include magneto-optic components, optical filters, non-linear crystals, color centers and quantum dots.

### CROSS-REFERENCE TO RELATED APPLICATION

This application claims the benefit of 63/535,441, filed Aug. 30, 2023, entitled “BULK OPTIC COMPONENTS INTEGRATED WITH OPTICAL WAVEGUIDES”, the contents of which are incorporated herein by reference.

### BACKGROUND

Lightguides, such as optical fibers and planar waveguides, have become ubiquitous in many applications including optical communications systems, sensor platforms and solid-state projection systems. It is often desirable to include one or more bulk optic components such as magneto-optic components, optical filters, non-linear crystals, color centers, quantum dots and the like, with the lightguides to perform a variety of functions in these systems.

Unfortunately, conventional bulk optic components are generally assembled from elements that may include, in case of magneto-optic components for example, polarizers and Faraday rotators. For instance, isolators, which are one example of a magneto-optic component, typically include two polarizers with a Faraday rotator located between them. The integration of a bulk component with optical fibers and planar waveguides can be difficult to accomplish.

In optical-fiber-based systems, for example, the addition of a bulk optical component can give rise to problems with size, yield, robustness, and reliability.

In planar-waveguide-based systems, such as planar lightwave circuits (PLCs) or photonic integrated circuits (PICs), it is difficult, if not impossible, to monolithically integrate bulk optic components with the planar waveguides. Accordingly, a hybrid integration approach is typically employed.

For example, International Pat. Publ. No. WO2023/009005A1, which is incorporated herein by reference, shows first and second optical waveguides formed in a substrate. An open cavity is formed between them. An isolator is arranged in the open cavity so that light exiting an end facet of the first optical waveguide traverses the isolator and is received by an end facet of the second optical waveguide. The isolator is located in the open cavity so that a gap is present between the end facet of each waveguide and the isolator. A lens is formed on the end facet of the first optical waveguide to collimate light received from the first optical waveguide and direct it to the isolator. Likewise, another lens is formed on the end facet of the second optical waveguide to collimate light into the second optical waveguide.

### SUMMARY

In one aspect, the present disclosure is directed to integration of a bulk optic component and optical waveguides on a common substrate in a manner that reduces reflections and scattering arising at the interfaces between the various elements. In particular, the bulk optic component is located in the optical path between first and second optical waveguides such that light exiting the first optical waveguide enters the bulk optic component, which is butt-coupled to the exit facet of the first optical waveguide. A refocusing lens that is disposed on an exit surface of the bulk component directs the light into the second optical waveguide. Examples of such bulk optic components include magneto-optic components, optical filters, non-linear crystals, color centers and quantum dots.

In one alternative embodiment the bulk optic component may be butt-coupled to the second optical waveguide so that a gap is formed between the first optical waveguide and the bulk optic component. In this case the lens may be formed on the input surface of the bulk optical component that receives the light from the first optical waveguide.

In some embodiments, the first and second optical waveguides are planar waveguides. In another embodiment, the first and second optical waveguides are optical fibers. In yet another embodiment, one of the optical waveguides is an optical fiber and the other optical waveguide is a planar waveguide.

Advantageously, the lens may be formed on the exit surface of the bulk optic component prior to its integration with the optical waveguides using conventional wafer scale technologies. In this way, the bulk optic component and the lens array form an integrated functional unit that may be placed and aligned with the optical waveguides as a single package, with no need to carefully fabricate the lenses in alignment with the optical waveguides. Moreover, multiple arrays of lenses may be simultaneously formed on a large bulk optic wafer or substrate prior to dicing or singulating the wafer into individual bulk optic components.

### BRIEF DESCRIPTION OF THE DRAWINGS

FIG. 1 shows a high-level conceptual block diagram of an optical arrangement in which a bulk-optic component is located between first and second waveguides.

FIG. 2 depicts a schematic drawing in a cross-sectional view of one example of a planar lightwave circuit (PLC) in accordance with the present disclosure.

FIG. 3 shows a schematic drawing of a top view of the PLC depicted in FIG. 2 with first and second waveguide arrays and a lens array.

FIG. 4 shows the output surface of a magneto-optic wafer on which two columns of lens arrays are formed.

### DETAILED DESCRIPTION

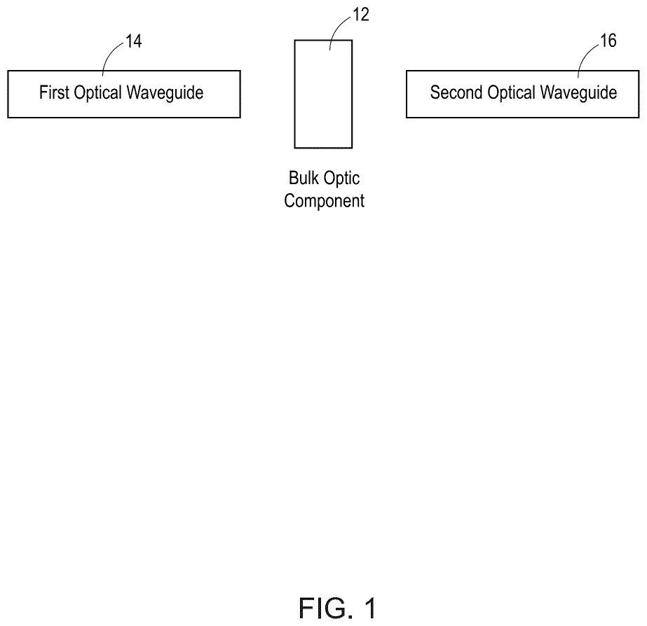

FIG. 1 shows a high-level conceptual block diagram of an optical arrangement in which a bulk optic component 12 is located between a first optical waveguide 14 and a second optical waveguide 16. The bulk optic component 12 is arranged so that light exiting the first optical waveguide 14 traverses the bulk optic component 12 and enters the second optical waveguide 16. The bulk optic component 12 may be, by way of example only and not as limitation on the subject matter described herein, a magneto-optic component, an optical filter, a non-linear crystal, a color center, a quantum dot and the like. The first and second optical waveguides 14 and 16 may be planar waveguides or optical fibers. Moreover, in some embodiments, one of the waveguides may be a planar waveguide and the other may be an optical fiber. For purposes of illustration, embodiments of the optical arrangement will be described below in more detail in terms of a planar lightwave circuit (PLC) in which the first and second waveguides are planar waveguides. Also by way of example only, the bulk optical component will be described below as a magneto-optic component such as an isolator, a circulator or a polarization rotator. In all cases however, the magneto-optic component more generally may be any suitable bulk optic component.

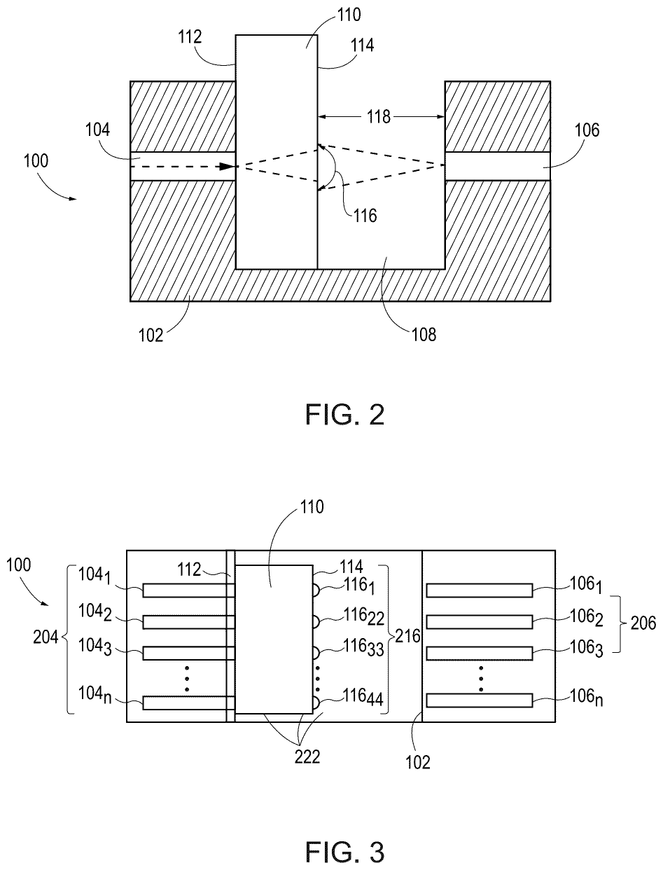

FIG. 2 depicts a schematic drawing in a cross-sectional view of one example of a PLC 100 in accordance with the present disclosure. The PLC 100 includes a substrate 102 in which a first optical waveguide 104 and a second optical waveguide 106 are formed as planar waveguides. A trench 108 is formed in the substrate 102 between the first and second optical waveguides 104 and 106. A magneto-optic component 110 is arranged in the trench 108 so that light exiting an end facet of the first optical waveguide 104 traverses the magneto-optic component 110 and is directed into an end facet of the second optical waveguide 106.

The magneto-optic component 110 is arranged in the trench 108 so that its input surface 112 is butt-coupled to the end facet of the first optical waveguide 104. The dimensions of the magneto-optic component 110 and the trench 108 are chosen that a gap 118 exists between the output surface 114 of the magneto-optic component 110 and the end facet of the second optical waveguide 106. A lens 116 is disposed on the output surface 114 of the magneto-optic component 110. The lens 116 focuses light from the magneto-optic component 110 into the end facet of the second waveguide 106. The lens 116 may be of any suitable type, such as a spherical lens, a cylindrical lens, a Fresnel lens or a metalens. The first and second waveguides 104 and 106, the magneto-optic component 110 and the lens 116 are aligned so that light (indicated in FIG. 2 by the dashed lines) entering the first waveguide 104 travels along an optical path through the magneto-optic component 110 and the lens 116 and enters into the second waveguide 106.

In some embodiments, a substance (e.g., index-matching gel, index-matching adhesive, etc.) is disposed between the end facet of the first optical waveguide 104 and input surface 112 to mitigate reflections at this interface.

It should be noted that in some embodiments the first and second waveguides are each a part of an array of waveguides and the lens is a part of an array of lenses. FIG. 3 shows a schematic drawing of a top view of the PLC 100 depicted in FIG. 2 with first and second waveguide arrays and a lens array. As shown, the first waveguide array 204 includes optical waveguides 104₁, 104₂, 104₃ . . . 104ₙ (“204”) and the second waveguide array 206 includes waveguides 106₁, 106₂, 106₃ . . . 106ₙ (“206”), where n≥1. Likewise, lens array 216 includes lenses 116₁, 116₂, 116₃ . . . 116ₙ (“216”). Each of the optical waveguides 204; in the first waveguide array 204 is optically aligned with a corresponding lens 216; in the lens array 216 and a corresponding optical waveguide 206; in the second waveguide array 206.

As those of ordinary skill in the art will recognize, the PLC 100 shown in FIGS. 2 and 3 may be fabricated from any of a variety of known materials and techniques. For instance, the substrate 102 may be formed from a semi-conductor, glass, polymer or other suitable material. Similarly, the waveguide structures may be any of type known in the art which are suitable for PLC applications. In one exemplary embodiment the waveguide structures may be TRIPLEX waveguides described in U.S. Pat. Nos. 7,146,087 and 7,142,759, each of which is incorporated herein by reference. In addition, trench 108 may be formed in the substrate 102 by any suitable technique such as etching, dicing, laser drilling or the like.

In some embodiments the lenses in the lens array 216 may be formed directly on the magneto-optic component 110 using any suitable technique such as additive manufacturing (e.g., 3D printing), a thermal reflw process, hot embossing, nano imprint lithography or two-photon laser lithography. Two-photon laser lithography is a microfabrication technique that uses a laser for polymerizing a photo-sensitive material such as a polymer to form a three-dimensional structure having any desired shape without the use of a mask or complex optical systems. In yet other embodiments the lenses may be formed by conventional photolithography techniques or any other conventional wafer scale technology. The material from which the lenses are formed is chosen to preferably have a refractive index close to an effective refractive index of the magneto-optic component 110 or the core of the optical waveguides (or anything therebetween) in order to reduce optical losses.

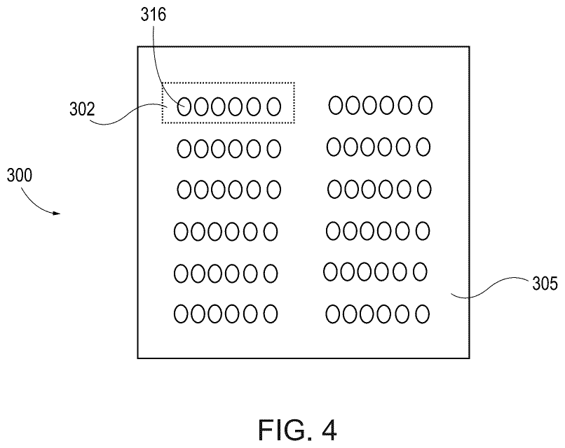

In some embodiments, multiple arrays of lenses are formed on a large magneto-optic wafer prior to dicing the wafer into individual magneto-optic components. For instance, FIG. 4 shows the output surface 305 of a magneto-optic wafer 300 on which two columns of lens arrays 302 are formed. In this example each lens array 302 includes 6 lenses 316. After fabricating the lenses, the magneto-optic wafer 300 may be diced into individual magneto-optic components 110 that each include an array of 6 lens. Each such magneto-optic component 110 is thereby suitable for use in a PLC 100 such as shown in FIG. 3 in which the first and second waveguide arrays 204 and 206 each include 6 waveguides.

The magneto-optic component 110 on which the lens array 216 is fabricated may be placed in the trench 108 as a single integrated functional unit 222. As shown in FIGS. 2 and 3, the input surface 112 of the integrated functional unit 222 is butt-coupled to the end facets of the first waveguide array 104 using, for example, an optically transparent adhesive that has a refractive index closely matched to that of the waveguides in the first waveguide array 204. The alignment between the first waveguide array 204, the magneto-optic component 110 with the lens array 216 and the second waveguide array 206 may be accomplished in any suitable manner. For example, the integrated functional unit 222 may be arranged in the trench 108 using a pick and place machine that has a sufficient degree of placement accuracy to perform the alignment without the need for any further adjustments. In some cases, an additional active alignment process may be employed to improve the accuracy of the alignment. For example, an active alignment process may be performed while optical power being transmitted through one or more waveguides in the first and second waveguide arrays 204 and 206 is monitored and the alignment adjusted to increase the power efficiency. Using these alignment techniques PLCs such as shown in FIG. 3 have been fabricated and shown to have an insertion loss of approximately less than-1 dB from the first waveguide array 204 to the second waveguide array 206.

In one embodiment the trench 108 may be optionally filled with an optically transparent filling material (e.g., an adhesive) after the single integrated functional unit 222 has been secured in place. The filling material can improve the degree to which the integrated functional unit 222 is mechanically secured in the trench 108 and also can prevent contaminants from entering the trench 108. The filling material preferably has a refractive index less than the refractive index of the material from which the lenses in the lens array 216 are formed. That is, in this embodiment the lens material is chosen to preferably have a refractive index based on the refractive index of the magneto-optic component 110 and the filling material. The filling material may or may not be the same as the adhesive used to butt-couple the integrated functional unit 222 to the end facets of the waveguides in the first waveguide array 204.

The optical arrangement in accordance with the various embodiments of the present disclosure offers a number of advantages over the known arrangement shown in aforementioned International Pat. Publ. No. WO2023/009005A1. For example, the known arrangement requires the fabrication of a lens on the facets of each of the waveguides in each pair of waveguides in the waveguide array. This involves the individual fabrication of each lens directly in the open cavity by, for example, filling the cavity with a photo-sensitive material that is polymerized and cured, followed by removal of the non-polymerized material. In contrast, the optical arrangement in accordance with the present disclosure only requires the fabrication of a single lens for each pair of waveguides in the waveguide arrays. Moreover, this single lens need not be formed in situ (in the open cavity), but can be formed on the magneto-optic component prior to its insertion in the trench. Moreover, the lens may be formed using conventional wafer scale technologies and may be formed on a large magneto-optic wafer so that multiple lenses may be simultaneously formed prior to dicing the wafer into individual magneto-optic components. In this way multiple magneto-optic components, each of which may have one or more lens formed on them, may be simultaneously formed.

As a further advantage, once the integrated functional unit comprising the magneto-optic component and the lens array 116 is fabricated, it may be placed and aligned with the waveguides as a single package, with no need to carefully fabricate the lenses in alignment with the waveguides. Furthermore, the known optical arrangement shown in the aforementioned International Pat. Publ. No. WO2023/009005A1 results in more interfaces than in the optical arrangement of the present disclosure, resulting in greater optical losses and reflections than arise in the optical arrangement of the present disclosure.

As previously mentioned in connection with FIG. 1, in some embodiments the optical waveguides may be optical fibers instead of planar waveguides. In these embodiments the integrated functional unit that includes the magneto-optic component and the lens array may be arranged between a first optical fiber array and a second optical fiber array. In these embodiments the substrate structure in which the optical fibers and the integrated functional unit are mounted may include V-grooves or like in which the optical fibers are secured. The integrated functional unit then may be arranged on the substrate structure between the two V-grooves so that light exiting an optical fiber in the first optical fiber array traverses the integrated functional unit and enters a corresponding optical fiber in the second optical fiber array. The end faces of the optical fibers in the first optical fiber array are butt-coupled to the magneto-optic component in the integrated functional unit in a manner similar to that described above in connection with the embodiments in which the optical waveguides are planar waveguides.

As noted above, the magneto-optic component illustrated in FIGS. 2-4 more generally may be any suitable bulk optic component. In addition, while in the examples presented above the magneto-optic component 110 (or more generally, the bulk optic component) is depicted as being butt-coupled to the first optical waveguide 104, in an alternative embodiment the magneto-optic component 110 may be instead butt-coupled to the second optical waveguide 106 so that a gap is formed between the first optical waveguide 104 and the magneto-optic component 110. In this case the lens 116 may be formed on the input surface 112 of the magneto-optic component that receives the light from the first optical waveguide 104.

1. An optical arrangement, comprising:
a first optical waveguide;
a second optical waveguide being arranged to define a gap between a first end facet of the first optical waveguide and a second end facet of the second optical waveguide that faces the first end facet of the first optical waveguide;
a bulk optical component having a first surface butt-coupled to the first end facet of the first optical waveguide or the second end facet of the second optical waveguide; and
a lens disposed on a second surface of the bulk optical component, wherein the first optical waveguide, the second optical waveguide, the bulk optical component and the lens are arranged such that light exiting the first end facet of the first optical waveguide traverses the bulk optical component and is focused by the lens into the second end facet of the second optical waveguide.

2. The optical arrangement of claim 1 wherein the first and second optical waveguides are planar waveguides.

3. The optical arrangement of claim 2 wherein the planar waveguides are disposed in a common substrate.

4. The optical arrangement of claim 3 further comprising a trench disposed in the substrate to form the gap between the first end facet of the first optical waveguide and the send end facet of the second optical waveguide.

5. The optical arrangement of claim 1 wherein at least one of the first and second optical waveguides is an optical fiber.

6. The optical arrangement of claim 2 wherein the first surface of the bulk optical component is butt-coupled to the first end facet of the first optical waveguide and the second surface of the bulk optical component on which the lens is disposed is an output surface.

7. The optical arrangement of claim 2 wherein the first surface of the bulk optical component is butt-coupled to the end facet of the second optical waveguide and the second surface of the bulk optical component on which the lens is disposed is an input surface.

8. The optical arrangement of claim 1 wherein:
the first optical waveguide includes a plurality of first optical waveguides defining a first optical array;
the second optical waveguide includes a plurality of second optical waveguides defining a second optical array, the first and second waveguide arrays being arranged to define a plurality of gaps between a first end facet of each of the first optical waveguides and a corresponding second facet of one of the second optical waveguides;
the bulk optical component includes a plurality of bulk optical components each having a first surface butt-coupled to a respective one of the first end facets of the first optical waveguides or a respective one of the second end facets of the second optical waveguide; and
the lens includes a plurality of lenses each respectively disposed on the second surface of one of the bulk optical components, the first optical array, the second optical array, the bulk optical components and the lenses being arranged such that light exiting the first end facet of each of the first optical waveguides traverses one of the bulk optical components and is focused by one of the lenses into the second end facet of a corresponding one of the second optical waveguides.

9. The optical arrangement of claim 1 wherein the first surface of the bulk optical component is butt-coupled to the first end facet of the first optical waveguide and further comprising a refractive index-matching material disposed between the first end facet of the first optical waveguide and the first surface of the bulk optical component.

10. The optical arrangement of claim 1 wherein the first surface of the bulk optical component is butt-coupled to the second end facet of the second optical waveguide and further comprising a refractive index-matching material disposed between the second end facet of the second optical waveguide and the first surface of the bulk optical component.

11. The optical arrangement of claim 1 further comprising an optically transparent material filling the gap.

12. The optical arrangement of claim 11 wherein the optically transparent material has a refractive index less than a refractive index of the lens.

13. The optical arrangement of claim 1 wherein the bulk optical component is a magneto-optic component.

14. The optical arrangement of claim 1 wherein the bulk optical component is selected from the group consisting of an optical filter, a non-linear crystal, a color center and a quantum dot.

15. A method of forming an optical arrangement, comprising:
forming a first and second optical waveguide in a substrate;
forming a trench in the substrate to define a gap between a first end facet of the first optical waveguide and a second facet of the second optical waveguide that faces the first end fact of the first optical waveguide;
arranging a bulk optical component in the trench, the bulk optical component having a first end surface butt-coupled to the first end facet of the first optical waveguide or the second end facet of the second optical waveguide; and
arranging a lens on a second surface of the bulk optical component, wherein the first optical waveguide, the second optical waveguide, the bulk optical component and the lens are located with respect to one another such that light exiting the first end facet of the first optical waveguide traverses the bulk optical component and is focused by the lens into the second end facet of the second optical waveguide.

16. The method of claim 15 wherein arranging the lens on the second surface of the bulk optical component further includes forming the lens on the second surface of bulk optical component before arranging the bulk optical component in the trench.

17. The method of claim 16 wherein the bulk optical component and the lens formed thereon define an integrated functional unit, and further comprising placing the integrated functional unit in the trench so that the first optical waveguide, the integrated functional unit and the second optical waveguide are aligned with one another.

18. The method of claim 17 further comprising performing an active alignment process when placing the integrated functional component in the trench to increase a power efficiency of light transmitted from the first optical waveguide to the second optical waveguide.

19. The method of claim 15 further comprising filling the trench with an optically transparent material.

20. The method of claim 15 further comprising butt-coupling the bulk optical component to the end facet of the first optical waveguide or the second end facet of the second optical waveguide using an optically transparent adhesive.

21. The method of claim 15 wherein arranging the lens on the second surface of the bulk optical component includes forming the lens on the second surface of the bulk optical component by a technique selected from the group consisting of additive manufacturing, thermal reflow, hot embossing, photolithography, nano imprint lithography and two-photon laser lithography.
